(19) United States
(12) Patent Application Publication
(10) Pub. No.: US 2024/0179006 A1
(43) Pub. Date: May 30, 2024

(54) PERFORMING VERIFIED RESTORE OF DATA ASSETS IN A CRYPTOGRAPHIC DEVICE

(71) Applicant: CRYPTOGRAPHY RESEARCH, INC., San Jose, CA (US)

(72) Inventor: Matthew E. Orzen, San Francisco, CA (US)

(21) Appl. No.: 18/520,068

(22) Filed: Nov. 27, 2023

Related U.S. Application Data
(60) Provisional application No. 63/428,292, filed on Nov. 28, 2022.

(51) Int. Cl. H04L 9/32; H04L 9/08

(52) U.S. Cl. CPC H04L 9/3236; H04L 9/0819

(57) ABSTRACT

A first platform receives a request to generate a verification package for restoring a backup image at a second platform. The first platform generates a first data asset. The first platform generates a second data asset based on the first data asset and an asset list associated with the backup image. The first platform generates a third data asset based on the asset list. The first platform sends a response that includes the verification package comprising the first data asset, the second data asset, and the third data asset.

### RELATED APPLICATIONS

This application claims the benefit of U.S. Provisional Patent Application No. 63/428,292 filed Nov. 28, 2022, the entire contents of which are incorporated by reference herein.

### TECHNICAL FIELD

Aspects and embodiments of the disclosure relate to cryptographic management (CM) systems, and more specifically, to systems and methods to verify backup and restore operations of a secure data asset.

### BACKGROUND

The need for a secure platform to verify the restore of a backup image is growing. Existing platforms typically do not include a mechanism to verify that data assets transferred via a backup and restore operation are correct in the restored image. Data assets usually cannot be exported from the secure platform and, as a result, the contents of the secure platform generally cannot be examined to verify that the backup and restore operation restored the correct data assets.

### BRIEF DESCRIPTION OF DRAWINGS

The present disclosure is illustrated by way of example, and not by way of limitation, in the figures of the accompanying drawings.

FIG. 1 illustrates a network diagram of a CM system, in accordance with some embodiments of the disclosure.

FIG. 2 is a sequence diagram illustrating backup asset creation at a cryptographic device, in accordance with some embodiments of the disclosure.

FIG. 3 is a sequence diagram illustrating restore and verification procedures at a cryptographic device, in accordance with some embodiments of the disclosure.

FIG. 4 depicts a flow diagram of an example method of using a module running on a cryptographic device in creating backup asset and verification data, in accordance with some embodiments of the disclosure.

FIG. 5 depicts a flow diagram of an example method of using a module running on a cryptographic device in executing a restore and verification procedure, in accordance with some embodiments of the disclosure.

FIG. 6 is a block diagram illustrating an exemplary computer system, in accordance with some embodiments of the disclosure.

### DETAILED DESCRIPTION

The embodiments described herein are directed to technologies of a secure asset management infrastructure for providing verification of a secure data asset restore to a cryptographic device. The secure asset management infrastructure (also referred to as cryptographic manager (CM) Ecosystem) may include a multi-device cryptographic manager system (hereinafter referred to as “CM system”) of hardware and software designed to provide secure chip manufacturing. The CM system may include various authorizing, customizing, and testing subsystems and other processes aimed at secure device manufacturing. The CM system may securely generate, process, and deliver sensitive data, such as secure data assets (e.g., encrypted data, cryptographic keys, authenticated data, a signed certificate, etc.). A CM system may typically include a CM root device (referred to herein as “root device” or “CM root device”), one or more CM control devices (referred to herein as “control device” or “CM control device”), and one or more manufacturing sites that include one or more CM appliance devices (also referred to as “appliance devices” or “appliance cluster”). The CM root device may protect master keys and authorize the setup, installation, configuration and operation of components of the CM system for any given manufacturing site. The CM control device may provide a way to centrally control and monitor operation of the CM system, as well as provision the secure data assets to an appliance cluster.

Secure data assets within a cryptographic device may be used within the boundary of the cryptographic device, but the secure data assets within the cryptographic device typically cannot be observed after provisioning of the secure data asset. For example, a particular module within a cryptographic device may provide a particular functionality (e.g., sign a certificate) using a particular private key. The cryptographic device may use the private key within the CM system, but it cannot share the private key. In some CM systems, when a backup and restore operation is performed, clients using the CM system rely on the CM system having a backup and restore procedure that will restore the correct secure data assets. However, CM systems typically only indicate whether the restore procedure was successful, not whether the correct data assets were restored. An incorrect restore of secure data assets may result in the irretrievable loss of data assets such as cryptographic keys. In some cases, fully redundant CM systems are utilized for backup and restore procedures solely to verify the restore procedure restored the correct data asset. This is typically done by exercising the use case of every secure data asset within the cryptographic device to ensure it is the identified data asset. Such a solution is expensive, cumbersome, and not feasible to implement in many CM systems.

Aspects of the disclosure address at least the above challenges among others by implementing a verification procedure in the backup and restore of secure data assets to a cryptographic device within a CM system. In some embodiments, a first platform (e.g., a source platform) may receive a request to generate a backup asset (e.g., a backup image) from a second platform (e.g., a target platform.). The source platform and the target platform may be, for example, hardware security modules (HSM). The request to generate the backup asset may include a public key of an asymmetric key pair (e.g., a public/private key pair), hereafter referred to as a “transport key.” The public/private key pair may be generated by the target platform.

Responsive to the request, the source platform may generate a symmetric key referred to as a “signing key.” The signing key may be used for generating digital signatures over secure assets generated during the backup operation. The source platform may then generate an asset list signature based on the signing key and an asset list. In some embodiments, the asset list may be obtained from the target platform and may contain a list of the assets (e.g., sensitive data, such as private cryptographic keys) for backup at the source platform. In some embodiments, the source platform may backup all the assets it contains and maintain an asset list referencing the assets. In some embodiments, the source platform may generate the asset list signature by signing the asset list using a hash function (e.g., hash-based message authentication code (HMAC)) and the signing key. The hash function may be, for example, a hash-based message authentication code (HMAC).

The source platform may generate a signed data asset using the secure data assets identified by the asset list and the signing key. In some embodiments, the source platform may generate the signed data asset by signing the secure data assets identified by the asset list with the signing key. The secure data assets may include cryptographic keys, authenticated data, and certificates. In some embodiments, the source platform may sign the secure data asset using an HMAC. The source platform may then encrypt the signing key using the transport key and send the backup image, the encrypted signing key, the signed asset list, and the signed secure data asset to the target platform.

Responsive to receiving the backup image, the target platform may perform a restore operation using the backup image. In some embodiments, the target platform may use the encrypted signing key, the signed asset list, and the signed secure data asset to verify the restore operation restored the correct data asset. In response to or in addition to the restore procedure, the target platform may decrypt the encrypted signing key using the transport key. In some embodiments, the source platform may have generated and sent the corresponding public transport key of the transport public-private key pair to the source platform prior to receiving the backup image as part of the request to the source platform to generate the backup image.

The target platform may verify the signed asset list using the signing key and the asset list. In some embodiments, the target platform may sign the asset list using a hash function and the signing key. The hash function may be the same HMAC used by the source platform to generate the asset list signature and signed data asset. The target platform may compare its signed asset list with the signed asset list received from the source platform. In some embodiments, if both signed assets lists match (e.g., are identical), the source platform may perform additional verification procedures. If the signed assets lists do not match, the source platform may return an error. Such an error may indicate that the asset list has been tampered with.

As noted, a technical problem addressed by embodiments of the disclosure is an inability of some systems to verify a restore operation of secure data assets. A technical solution to the above identified technical problems may include implementing verification procedure in the backup and restore of secure data assets.

A data asset (also referred to a “secure data asset” or “secure asset” herein) may refer to sensitive data that is generated, at least in part, by a module or hardware security module. A data asset may include one or more of encrypted data (e.g., cryptographic keys), authenticated data (e.g., confirmation of the origin and/or integrity of the data), or a certificate (e.g., a data block authenticated using an authenticating digital signature).

A hardware security module (HSM) may refer to a tamper-resistant physical computing system used to safeguard the processing and storage of sensitive data. The HSM may include hardware (e.g., one or more cryptographic processing devices), software or a combination thereof that operate together to safeguard the sensitive data. The HSM may safeguard and manage digital keys, perform encryption and decryption functions for digital signatures, perform strong authentication or other cryptographic functions. The HSM may securely store digital keys that are not exported or transmitted from the secure boundaries of the HSM. In some embodiments, an HSM may be a plug-in card or an external device that attaches directly to a computer or network server. If the HSM were to be maliciously opened, the keys and potentially some hardware of the HSM would be destroyed and unrecoverable.

A module may refer to data and/or software code, often custom firmware that may run inside an HSM and that may perform security sensitive computations. The execution of the module may result in a module response that may include providing or generating one or more secure data assets. The module may be designed to provide a single type of transaction such as backup operation or a restore operation.

Various aspects of the above referenced methods and systems are described in detail herein by way of examples, rather than by way of limitation. The embodiments and examples provided below are discussed in relation to a cryptographic manager system. The cryptographic manager system is discussed by way of illustrative example. As such, it is noted that aspects of the present disclosure, such as, for example, those relating to execution of a backup operation and execution of a restore and verify operation, can be applied to any type of computer and/or electrical system, configuration, or architecture. For example, aspects of the present disclosure can be used as part of system-on-chip (SoC) firmware implemented in any type of computer system.

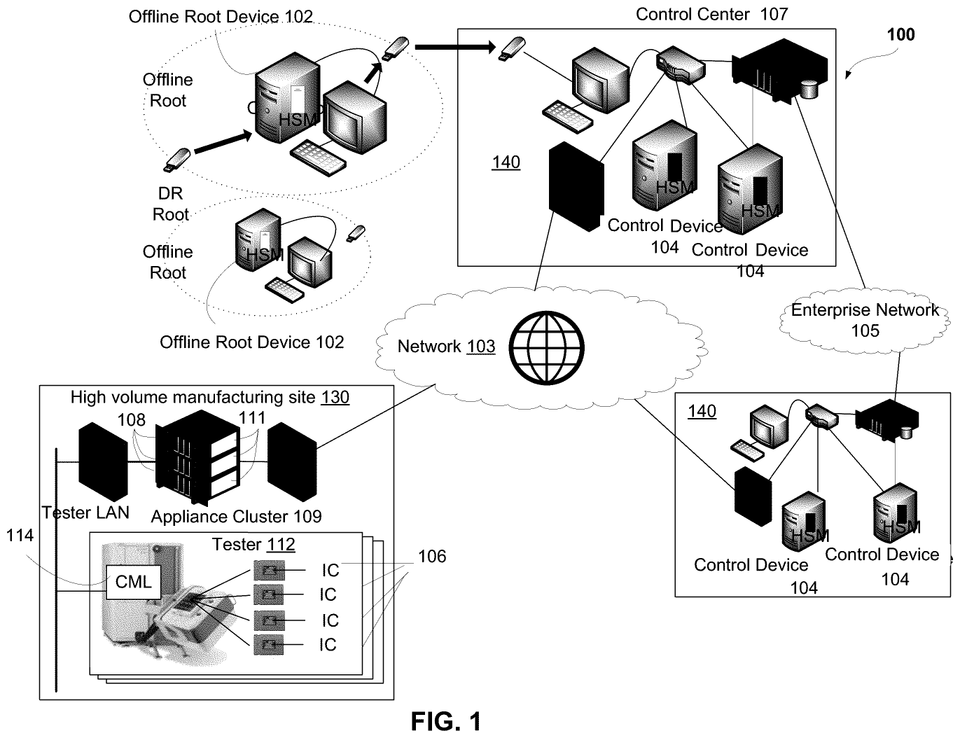

FIG. 1 illustrates a network diagram of a CM system 100, in accordance with some embodiments of the disclosure. The CM system 100 may include a variety of cryptographic manager (CM) devices. In some embodiments, the CM system 100 may provide secure transaction processing and data reporting infrastructure designed to provide secure key and asset management capabilities to a target device 106 (e.g., mobile devices) through a web service interface. The user or customer for the CM system 100 may include fabless semiconductor vendors, for example, that produce chipsets for mobile devices, system integrators (OEMs) that manufacture internet connected devices, or mobile network operators (MNOs) that deploy these devices on their wireless networks, etc. Such customers may contract out some of the fabrication of their devices or components to third-party manufacturers that operating remote manufacturing facilities, such as a high-volume manufacturing site 130. As a mission critical part of the customer's manufacturing and communications systems, design priorities for the CM system 100 are high availability and integrity.

The CM system 100 includes a root device 102 that is an entity which authorizes installation, configuration and operation of the CM System 100. The root device 102 may protect master keys and authorize the setup, installation, configuration and operation of components of the CM system 100 for any given site, such as manufacturing site 130. In some embodiments, the root device 102 may be considered an offline root that authorizes setup and major configuration parameters in the operation of the CM System. In some embodiments, data is transferred to and from the root device 102 by a removable storage device, such as a Universal Serial Bus (USB) Flash drive or the like. Computer systems are subject to trade-offs between security and convenience. Given that the main task of the root authority, at least in some embodiments, is to protect master keys that underpin security of an entire CM deployment, the root authority design is driven by the need for security. This is why the root authority may be, at least in some embodiments, air-gapped (i.e., not connected to any computer network). Additionally, an HSM may be used to protect most important keys stored by the root authority. Because the root authority is off-line, it is not assumed to be continuously available. As a result, the root authority may authorize a range of permitted actions in advance so that it is not necessary to involve the root authority when an action needs to be taken. The root authority's authorizations are provided to the control device, where decisions are made about which authorizations will actually be used.

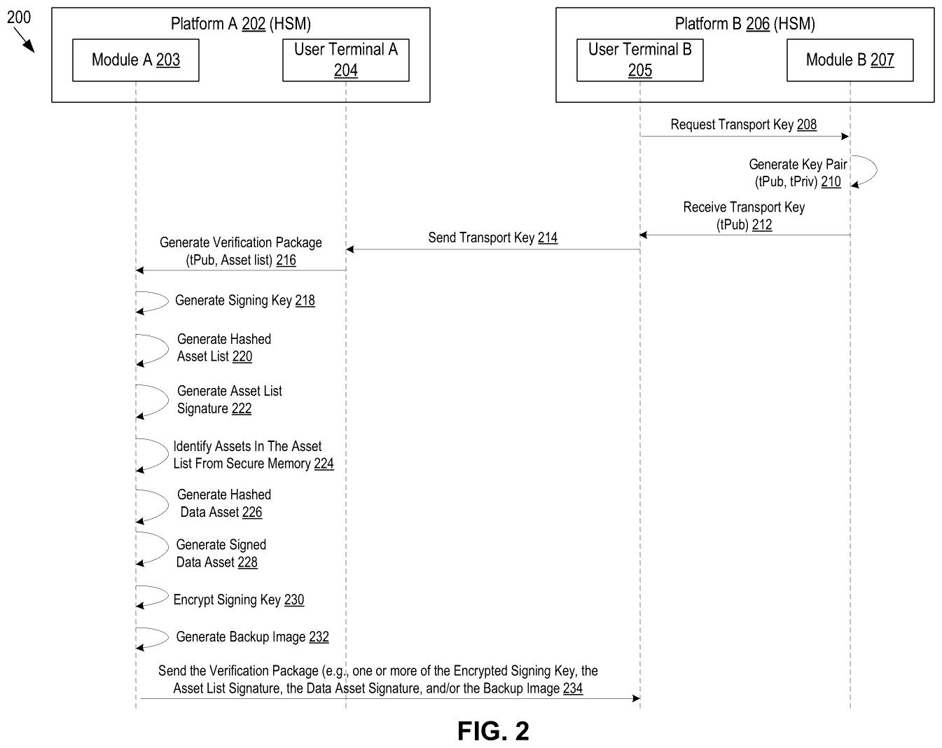

In some embodiments, operations of the root device 102 can be initiated by one or more user terminals connected to the root device 102. A user terminal can include a command line interface (CLI) of a display device coupled to the CM root 102 (e.g., user terminal A 204 and user terminal B 205 discussed in FIG. 2). A user terminal can initiate a session or access a session already initiated. The session can include a request for the root device 102 to generate a secure data asset, generate a transport key, etc. In response to the request, the root device 102 can execute the request to generate a secure data asset, generate a transport key, etc. In some embodiments, user terminals may be accessed by one or more particular operators upon verification of a set of credentials (e.g., password, authentication token, radio-frequency identification (RFID), etc.).

A control center 107 (hereinafter “control” or “control center”), including one or more control devices 104, provides a way to centrally control and monitor operation of the CM system 100, as well as provision data to an appliance cluster 109 (a collection of one or more appliance devices 108), in accordance with some embodiments of the disclosure. In some embodiments, the control device 104 may include a hardware appliance used to facilitate central management of the CM System 100 and to provision data to an appliance cluster 109. Additionally, a control device 104 may distribute (via appliance devices 108) on or more of modules, context data, applications, library component, version data of the library component, other data or security parameters destined for target devices 106. In some embodiments, a target device 106 includes at least one memory device to store data assets. In some embodiments, target device 106 includes a monolithic integrated circuit. In some embodiments, the control devices 104 of the control center 107 may reside in the customer's physically secure corporate data center 140 and may provide a turn-key security service to the customer to manage its data assets in a remote manufacturing site 130. In another embodiment, the control center 107 may include multiple control devices 104 at multiple data centers 140 connected over an enterprise network 105, as illustrated in FIG. 1.

In some embodiments, a data asset may include a digital data file, such as an HDCP. Device Key Set, which is to be securely transferred to a target device 106 (e.g., CM core). A data asset may include any sensitive data such as keys, serial numbers, and firmware that are managed securely through the CM system and provisioned to target devices at various lifecycle stages from manufacturing supply chain to the end user. Data assets may be device-specific. For example, perso1, perso2, and device serialization records are data assets. An organization may create and sell HDCP keys. For example, a customer buys their keys from the organization, and then imports HDCP keys into the CM Service. The import process may reformat the key file as a pre-computed (PCD) file and encrypt it so that only suitably authorized appliance devices may access the PCD file. The appliance cluster 109 may be responsible for locally hosting sensitive data assets to be transferred to the target devices 106 during the process of manufacturing the target devices 106 at the manufacturing site 130.

The capability to manage the distribution network of appliance clusters 109 and to provision data assets (e.g., PCD assets), ticket authorizations, applications, contexts modules, library components, and library version identifiers across a network 103 of security appliance devices 108 may be provided by a web service interface to users of the CM system 100. The appliance cluster 109 may be responsible for securely storing sensitive data (e.g., data assets) locally in the manufacturing facility site 130 and for making that data assets highly available in a low latency manner to a target device 106, such as a system-on-a-chip (SoC) or a subcomponent on such an SoC, during the process of semiconductor device test and/or manufacturing. The target device 106 may be integrated into the SoC design during the design phase of the SoC to provide cryptographic control of SoC feature activation, configuration management, and secure key management.

In some embodiments, the target devices 106 each include one or more CM cores. In some embodiments, a specialized CM core may include a specialized integrated circuit, which may be implemented in some embodiments described herein. It should be noted that aspects of the disclosure may be applied to CM cores (e.g., integrated circuits) generally, as well as to specialized CM cores. In some embodiments, the specialized CM core may include a hardware core capable of executing a set of commands (e.g., sequence), which may be the building blocks for delivering functionality to a product (target device 106). The specialized CM core may be a hardware core that is configured to execute a set of commands to provide cryptographic control of the secure data asset when the target device is deployed in a product. For example, the set of command may include one or more of a command feature that includes command activation of one or more features of the target device 106 or a command for secure key management of the target device. A sequence may refer to software (e.g., script) and/or data that assists in the provisioning of a data asset to a target device. In some embodiments, the module may securely generate a unique sequence based on information, such as one or more a context, PCD, arguments or other information. The sequences may provide secure and authenticated programming instructions to the target device. A sequence may include a sequence of operations to be performed as a transaction of a specific transaction type with respect to a target device (e.g., specialized CM core).

An appliance device 108 may include one or more servers designed to provide secure computation, digital signing and distribution of data assets to target devices 106. In some embodiments, appliance devices 108 each contain a hardware security module (HSM) 111, which serves both as a vault safeguarding sensitive data and as a platform for execution of a module. Additionally, appliance device 108 generates, collects, protects, digitally signs and sends a variety of logging information to the customer via the control center 107. In some embodiments, an appliance device 108 may execute an application the runs on a high level OS. In some embodiments, the application may be executed outside the HSM 111.

The appliance cluster 109 is a group of appliance devices 108 providing increased availability of the services offered by an appliance device 108. If a particular appliance device 108 is unable to fulfill a request, a Tester device 112 may connect to any other appliance device 108 in the same appliance cluster 109 to continue service without major interruption.

In some embodiments, tester device 112 is a machine used in semiconductor device fabrication to test whether devices perform properly. The CM system uses tester devices 112 to program data, such as data assets, during wafer sort and package test, in some embodiments. In some embodiments, a tester device 112 is generally an untrusted device, located at the manufacturer's site 130, used to deliver data assets to the specific target devices 106. In some embodiments, the tester device 112 is a device designed to perform validation, characterization, and high-volume manufacturing tests. Tester device 112 may run a series of semiconductor tests, one or several of which will be a part of the CM System operation. The tester device 112 is relied on to initiate the communications with the appliance cluster 109 and to provide logging information.

In some embodiments, the tester device 112 may access a client library 114. The client library 114 may be a software component to be integrated with a primary application of the tester device 112. The client library 114 may be the CM client library. The tester device 112 may use the CM client library to access functions and/or procedures used with the application in provisioning a secure data asset to a target device 106.

To make the data available to the target device 106, the appliance cluster 109 may be connected to the asset management service, called control center 107, over a network 103, such as the public internet, a private network, and/or combinations thereof. The appliance cluster 109 may reside in a data center of the outsourced manufacturing facility site 130 and may act as a proxy to the control center 107. The appliance clusters 109 make available a secure and highly available local inventory of data (e.g., PCD assets) and ticket authorizations during manufacture to target devices 106 using strong authentication and access control in a low latency manner.

In some embodiments, the provisions and/or installation of a data asset to a target device 106 may be referred to as an asset-management transaction. A single appliance cluster 109 may run many modules and each module may be designed to provide a single type of transaction to a target device. The security sensitive computations used or performed by the module may be performed on a HSM 111. Other operations (typically less security sensitive operation) related to the asset-management transaction may be performed by the application. In some embodiments, the application executes on the same or different appliance cluster 109, but outside the HSM 111. In some embodiments, the application executes outside the appliance cluster 109. A module, along with the tamper-proof HSM 111 on which the module executes, may consume a target device specific authorization, or ticket, from a bulk authorization file provisioned by the control center 107 to the appliance device 108 or appliance cluster 109.

In some embodiments, a PCD template is a description of how the PCD, which, in some embodiments, becomes input for a particular type of module, is formatted. In some embodiments, the application may also use the PCD to, or example, generate another PCD or perform one or more cryptographic checks. A PCD type is a set of PCDs based on a particular PCD template, having a particular property, such as uniqueness, serialization, etc. For example, a PCD may include CM root-generated keys, serial numbers etc. that are securely packaged such that only the CM core (e.g., specialized CM core) on a target device 106 may provision the data. In another example, the PCD includes keys from various vendors (for example, HDCP keys) securely managed from the CM control to the target device. Key data are transformed into PCD on loading into the control.

It should be noted that various portions of the description refer to components of the CM system 100, such as toot, control or appliance as logical entities. Sometimes the internal structure of a logical entity is important. In some embodiments, a control entity may include one or more servers, a shared file system, a shared database, or the like. In the contexts where internals of control center 107 are important and each of these servers is viewed as a logical entity, each of them is referred to as control device, to distinguish it from the control entity (which represents control devices as well as shared resources). In some embodiments, a toot device 102 may include a server implementing the functionality of the root authority. In some embodiments an appliance device may include one or more servers e.g., a member of the appliance cluster 109 of appliance devices 108. In some embodiments, a target device 106, typically a CM core (e.g., integrated circuit of the target device), is the consumer of the functionality of the CM system 100. In some embodiments, the root devices 102, control devices 104 and appliance devices 108 each include a main computing device (e.g., one or more processing devices or the like) as well as an embedded HSM 111. Some of the identifiers (IDs) and cryptographic keys will be stored inside the HSM 111, while others will be stored on the device's hard drive. Exact location of the IDs or keys may be determined based on their sensitivity and the implementation details as described herein. In some embodiments, IDs are used to identify components within the CM system 100. Some of the components are entities (e.g., control center 107), while others are devices (e.g., control device 104).

FIG. 2 is a sequence diagram illustrating execution of a backup operation at a CM system, in accordance with some embodiments of the disclosure. Diagram 200 may include similar elements as illustrated in CM system 100 as described with respect to FIG. 1. It may be noted that elements of FIG. 1 may be used herein to help describe FIG. 2. The operations described with respect to FIG. 2 are shown to be performed serially for the sake of illustration, rather than limitation. Although shown in a particular sequence or order, unless otherwise specified, the order of the operations may be modified. Thus, the illustrated embodiments should be understood only as examples, and the illustrated operations may be performed in a different order, while some operations may be performed in parallel. Additionally, one or more operations may be omitted in some embodiments. Thus, not all illustrated operations are required in every embodiment, and other process flows are possible. In some embodiments, the same, different, fewer, or greater operations may be performed.

Diagram 200 illustrates platform A 202 (also referred to as “source platform” or “source HSM” herein), and platform B 206 (also referred to as “target platform” or “target HSM” herein). Platform A 202 may be any cryptographic device that retains secure data assets. In some instances, the secure data assets cannot be observed or utilized outside the secure boundary of platform A. Platform B 206 may be any cryptographic device that retains secure data assets. In some instances, the secure data assets cannot be observed outside the secure boundary of platform B. In some embodiments, module A 203 and user terminal A 204 may be operating on platform A 202 and module B 207 and user terminal B 207 may be operating on platform B 206. In some embodiments, platform A 202 may be an HSM of an appliance 108 of an appliance cluster 109 and platform B 206 may be an HSM of the same or different appliance 108 or appliance cluster 109. In embodiments where both platform A 202 and platform B 206 are operating on an appliance (same or different), module A 203 may be executing on a first processing device (typically a secured and trusted processing device within the platform A 202, such as a process device of an HSM 111) and module B 207 may be executing on a second processing device (typically a secured and trusted processing device operating within platform B 206, such as a processing device of an HSM 111). In other embodiments, platform A 202 and platform B 206 may be entirely separate systems. For example, module A 203 may be executing at an HSM 111 of an appliance 108 and module B 207 may be executing at an HSM outside appliance cluster 109. In some embodiments, platform A 202 is not directly connected to a network and/or cannot makes calls (e.g., system calls) to other devices outside the appliance cluster 109. In some embodiments, platform B 206 is not directly connected to a network and/or cannot makes calls to devices outside the appliance cluster 109. In some embodiments, data may be transferred between platform A 202 and platform B 206 via user terminal A 204 and user terminal B 205. In some embodiments, user terminal A 204 and user terminal B 205 may communicate with each other via, for example, a removable storage device, such as a Universal Serial Bus (USB) Flash drive or the like. In some embodiments, each user terminal may be accessed by one or more particular operators upon verification of a set of credentials (e.g., password, authentication token, radio-frequency identification (RFID), etc.).

At operation 208, user terminal B 205 sends, to module B 207, a request to generate a transport key. A transport key may be a data asset used to encrypt other data assets (e.g., a signing key) for transportation between platform A 202 and platform B 206. In some embodiments, the transport key may be a component (e.g., a public key (tPub) or a private key(tPriv)) of a public/private key pair (e.g., a Rivest-Shamir-Adleman (RSA) key pair). A public key of the key pair may be used to encrypt data that may be decrypted by a corresponding private key of the key pair. The request may include or identify a module name and module identification number to invoke an element of module B 207 to generate the transport key. In some embodiments, the request may be invoked by user input received from an operator via user terminal B 205.

At operation 210, module 206 generates the transport key. For example, module 206 may generate a public/private key pair, of which the public key may be the transport key. In some embodiments, the private key of the key pair may be retained and used only within platform B 206, while the public key of the transport key pair may be used by platform 202, as described below.

At operation 212, user terminal 205 receives the transport key from module B 207. In some embodiments, the transport key received from module B 207 may be the public key of the key pair generated at operation 210.

At operation 214, the transport key may be sent from platform B 206 to platform A 202. In some embodiments, the transport key may be sent from user terminal B 205 to user terminal A 204 via a removable storage device, such as a USB flash drive or the like. In some embodiments, the transport key may be sent from user terminal B 205 to user terminal A 204 via a wired or wireless connection.

At operation 216, user terminal A sends a request, to module A 203, to generate a verification package. The verification package may include one or more secure data assets used to perform and/or verify a response procedure. The verification package, once generated, may include an encrypted signing key, an asset list signature, a signed data asset, and/or a backup image. The request may include the transport key and/or an asset list that identifies a one or more of secure data assets to verify during a restore operation. In some embodiments, the asset list may be a text file that lists identifiers, such as names, of the secure data assets that are stored within platform A 202 (e.g., key1, key2, key3, etc.). Module A 203 may recognize that each identifier in the asset list corresponds to a secure data stored within the secure boundary of platform A 202. In some embodiments, module A 203 may generate the asset list based on one or more of the keys provisioned and stored within platform A 202.

In some embodiments, the asset list can be generated by module B 207. For example, in response to the request to generate the transport key or to a separate user input, module B 207 may generate the asset list. The asset list may then be received from platform B 206 by user terminal A 204. For example, the asset list may be sent from user terminal B 205 to user terminal A 204 via a removable storage device, via a wired or wireless connection, etc.

At operation 218, module A 203 generates a signing key. The signing key may be a cryptographic key, a symmetric key, etc. The signing key may be used by module A 203 to generate digital signatures and/or perform various hashing functions over cryptographic material stored by platform A 202. In some embodiments, the signing key may be used for hash-based message authentication (“HMAC”) of the asset list and the secure data assets stored within platform A 202. In some embodiments, the signing key may be a random 256-bit value generated by module A 203, a random value of differing bit length (e.g., 64, 128, 612, etc.), etc. In some embodiments, the signing key can be generated using a Diffie-Hellman algorithm.

At operation 220, module A 203 generates a hashed asset list. To generate the hashed asset list, module A 203 may perform a cryptographic operation (e.g., a hashing operation, a signing operation, etc.) on the asset list. For example, module A 203 may perform a hashing operation on the asset list using a SHA-256 hashing function. As noted herein, the hashing function may be any hashing function such as SHA-612, MD5, RIPEMD-256, etc. In some embodiments, the resulting hashed asset list may be the first of two passes of HMAC digital signature generation over the asset list. In some embodiments, other cryptographic operations can be performed to cryptographically sign or encrypt the asset list.

At operation 222, module A 203 generates an asset list signature. To generate the asset list signature, module A 203 may perform a cryptographic operation on the hashed asset list and the signing key. For example, module A 203 may input the hashed asset list and the signing key into a hash function and receive, as output, the asset list signature. In some embodiments, module A 203 may generate the asset list signature using HMAC digital signature generation. The resulting asset list signature may be the second pass of two passes of the HMAC digital signature generation over the asset list.

At operation 224, module A 203 identifies the secure data assets of the asset list from a secure memory element of platform A 202. Module A 203 may be communicatively coupled to a secure memory device within platform A 202. As noted herein, the secure data asset(s) may include one or more of encrypted data, authenticated data, or certificates. Examples of the secure data asset may include but is not limited to one or more of a signed certificate, cryptographic keys, random number generated values (or related values), or unique device identifiers.

At operation 226, module A 203 generates a hashed data asset. To generate the hashed data asset, module A 203 may perform a cryptographic operation (e.g., a hashing operation, a signing operation, etc.) on the secure data assets identified at operation 222. For example, module A 203 may a hashing operation using a SHA-256 hashing function. As noted herein, the hashing function may be any hashing function such as SHA-612, MD5, RIPEMD-256, and the like. In some embodiments, the resulting hashed data asset from performing operation 224 may be the first of two passes of HMAC digital signature generation over the secure data asset.

At operation 228, module A 203 generates a signed data asset. To generate the signed data asset, module A 203 may perform a cryptographic operation on the hashed data asset. For example, module A 203 may input the hashed data asset and the signing key into a hash function and receive, as output, the signed data asset (also referred herein as “data asset signature.”). In some embodiments, module A 203 may generate the signed data asset using HMAC digital signature generation to generate the signed data asset using the hashed data asset and the signing key. In such an embodiment, the resulting signed data asset may be the second pass of two passes of HMAC digital signature generation over the secure data asset.

At operation 230, module A 203 encrypts the signing key. In some embodiments, the signing key may be encrypted using the transport key received from platform B 206. In some embodiments, module A 203 may encrypt the signing key using one or more encryption methods. In some embodiments, the signing key may remain unencrypted.

At operation 232, module A 203 generates the backup image of the data assets identified in the asset list. The backup image may include cryptographic keys stored within platform A 202. In some embodiments, the backup image may be encrypted using one or more cryptograph operations (e.g., a cryptographic key on a smart card, multiple cryptographic keys on different smart cards, etc.).

At operation 234, module A 203 sends the verification package (e.g., at least one of the encrypted signing key, the asset list signature, the signed data asset, and/or the backup image) to platform B 206 (via, for example, user terminal A 204). In some embodiments, one or more of the encrypted signing key, the asset list signature, and the signed data asset may all be data assets used as part of a verification procedure performed subsequent to a restore procedure of the backup image. The verification package may be received from platform A 202 by user terminal B 205. For example, the verification package may be sent from user terminal A 204 to user terminal B 205 via a removable storage device, via a wired or wireless connection, etc.

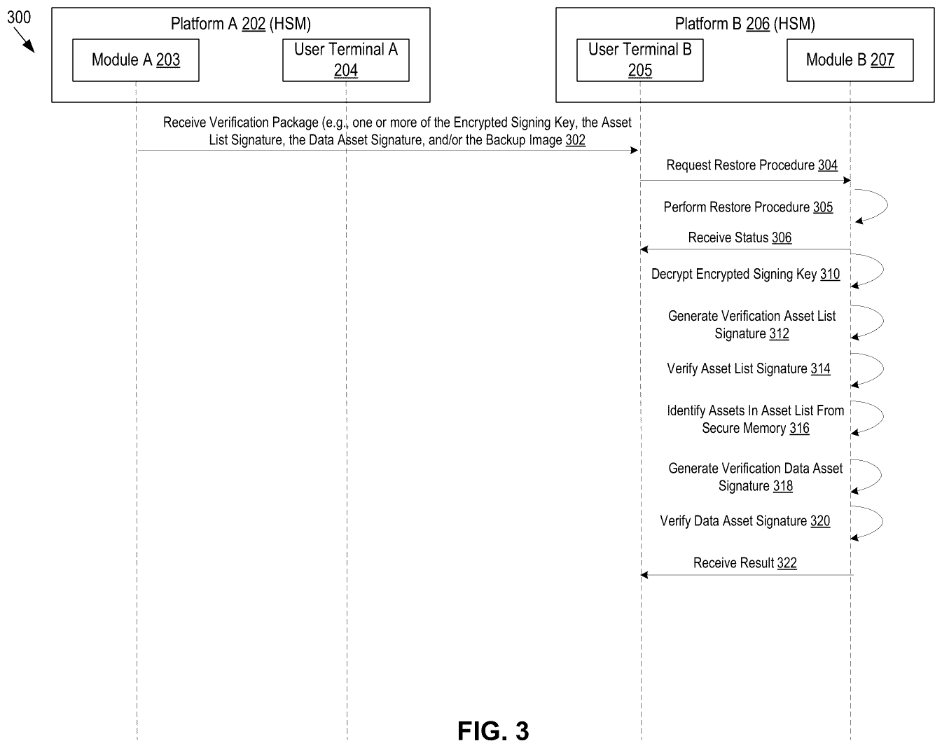

FIG. 3 is a sequence diagram illustrating execution of a restore and verify operation at a CM system, in accordance with some embodiments of the disclosure. Diagram 300 may include similar elements as illustrated in CM system 100 as described with respect to FIG. 1 and FIG. 2. It may be noted that elements of FIG. 1 and FIG. 2 may be used herein to help describe FIG. 3. The operations described with respect to FIG. 3 are shown to be performed serially for the sake of illustration, rather than limitation. Although shown in a particular sequence or order, unless otherwise specified, the order of the operations may be modified. Thus, the illustrated embodiments should be understood only as examples, and the illustrated operations may be performed in a different order, while some operations may be performed in parallel. Additionally, one or more operations may be omitted in some embodiments. Thus, not all illustrated operations are required in every embodiment, and other process flows are possible. In some embodiments, the same, different, fewer, or greater operations may be performed. In some embodiments, platform A 202 of FIG. 3 may be similar or the same as platform A 202 of FIG. 2, and platform B 206 of FIG. 3 may be similar or the same as platform B 206 of FIG. 2.

At operation 302, platform B 206 receives a verification package. The verification package may be received from platform A 202 by user terminal B 205. For example, the verification package may be sent from user terminal A 204 to user terminal B 205 via a removable storage device, via a wired or wireless connection, etc. 202. The verification package may include one or more secure data assets used to perform and/or verify a restore procedure. The verification package may include an encrypted signing key, an asset list signature, a signed data asset, and/or a backup image. The verification package may be the verification package generated at operation 216 according to FIG. 2.

At operation 304, user terminal B 205 sends, to module B 207, a request to perform a restore procedure of the backup image. In some embodiments, the backup image contains assets identified in the asset list (e.g., asset list identified at operation 216) to be restored to platform B 206. In some embodiments, the backup image may be encrypted, and module B 207 may perform one or more decryption procedures (e.g., one or more cryptographic keys stored on corresponding smart cards) prior to performance of the restore operation. In some embodiments, the request may be invoked by user input received from an operator via user terminal B 205.

At operation 306, user terminal B 205 receives a restore status from module B 207. The status may indicate whether module B 207 successfully performed the restore procedure of the backup image to platform B 206, or failed to perform the restore procedure.

Responsive to the status indicating a successful restore procedure, at operation 308, user terminal A 204 sends a request to user terminal B 205 to verify restore procedure 305. The request may include the verification package received at operation 302. The verification package may include the asset list identified at operation 216, the encrypted signing key generated at operation 218, the asset list signature generated at operation 222, and the signed data asset generated at operation 228. It is noted that the verification procedure may indicate whether the restore procedure at operation 304 restored the indicated secure data assets, or additional/other data assets.

At operation 310, module B 207 decrypts the encrypted signing key. In some embodiments, a key previously generated by module B 207 may be to used decrypt the encrypted signing key (e.g., be the public key of the key pair generated at operation 210). In some embodiments, the key may the transport key. The key may be a component (e.g., a public key (tPub) or a private key (tPriv)) of a public/private key pair (e.g., an RSA key pair). Module B may decrypt the encrypted signing key using the private key portion of the key pair. A private key of the key pair may be used to decrypt data that has been encrypted by a corresponding public key of the key pair. In embodiments where the signing key is unencrypted, module B 207 may proceed to operation 312.

At operation 312, module B 207 generates a verification asset list signature. In some embodiments, module B 207 performs generates the verification asset list signature by performing the cryptographic operations performed at operation 220 and operation 222 on the asset list using the signing key and the asset list.

At operation 314, module B 207 verifies the asset list signature. In some embodiments, module B 207 may compare the asset list signature and verification asset list signature to verify the asset list has not been changed or tampered with. In some embodiments, if the asset list signature and the verification asset list signature are not identical, module B 207 may return a negative result to user terminal B 205. The negative result may indicate that the restore procedure did not restore the correct data assets.

At operation 316, module B 207 identifies secure data assets of the asset list from a memory element of platform B 206. Module B 207 may be communicatively coupled to a secure memory device within platform B 206. As noted herein, the secure data asset may include one or more of encrypted data, authenticated data, or certificates. The secure data assets may be the secure data assets restored from the restore procedure performed at operation 305.

At operation 318, module B 207 generates a verification signed data asset. Module B 207 may generate the verification signed data asset using cryptographic operations on the secure data assets to generate a hash, signature, etc. over the secure data assets using the signing key. In some embodiments, the cryptographic operations may be the same cryptograph operations performed at operation 218 and operation 220.

At operation 320, module B 207 verifies the signed data asset. In some embodiments, module B 207 may compare the data list signature with verification signed data asset in order to verify the asset list has not been changed or tampered with. In some embodiments, if the asset list signature and the verification asset list signature are not identical, user terminal B 205 may return a negative result. The negative result may indicate that the restore procedure did not restore the correct data assets.

At operation 322, user terminal B 205 receives a result from module B 207. The result may indicate the outcome of the verification procedures describes above. If the asset list signature and the verification asset list signature are not identical, the result may be negative. If the signed data asset and the verification signed data asset are not identical, the result may be negative. In some embodiments, a negative result may indicate the restore procedure did not restore the correct data assets. If the asset list signature and verification asset list signature are the same, and the signed data asset and verification signed data asset are the same, the result may be positive. A positive result may indicate the restore procedure restored the correct data assets.

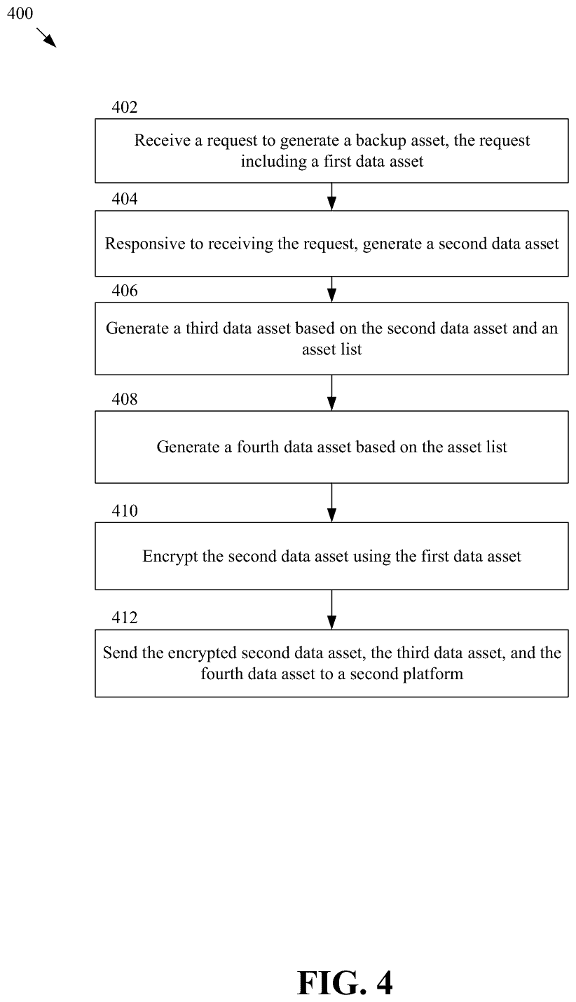

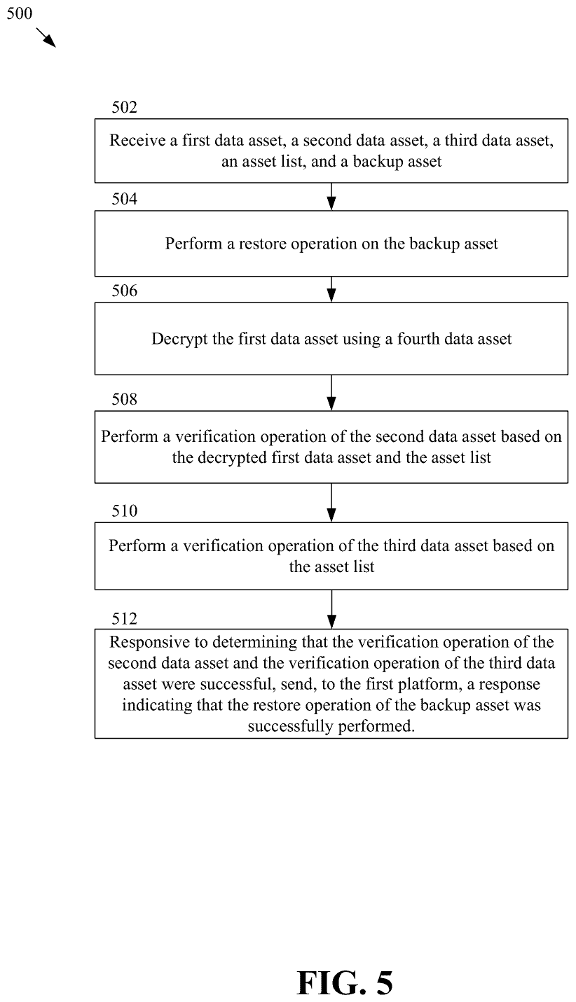

Methods 400 and/or 500 and/or each of the aforementioned methods' individual functions, routines, subroutines, or operations may be performed by a processing device, having one or more processing units (CPU) and memory devices communicatively coupled to the CPU(s). In some embodiments, the aforementioned methods may be performed by a single processing thread or alternatively by two or more processing threads, each thread executing one or more individual functions, routines, subroutines, or operations of the method. The aforementioned methods as described below may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 may be performed by a CM module, such as module A 203 described in FIG. 1, FIG. 2, and FIG. 3. In some embodiments, method 600 is performed by a CM module, such as module B 207 described in FIG. 1, FIG. 2, and FIG. 3. Although shown in a particular sequence or order, unless otherwise specified, the order of the operations may be modified. Thus, the illustrated embodiments should be understood only as examples, and the illustrated operations may be performed in a different order, while some operations may be performed in parallel. Additionally, one or more operations may be omitted in some embodiments. Thus, not all illustrated operations are required in every embodiment, and other process flows are possible. In some embodiments, the same, different, fewer, or greater operations may be performed. It may be noted that elements of FIG. 1, FIG. 2, and FIG. 3 may be used herein to help describe FIG. 4 and FIG. 5.

FIG. 4 depicts a flow diagram of an example method of using a module running on a cryptographic device in creating backup asset and verification data, in accordance with some embodiments of the disclosure.

At operation 402 of Method 400, processing logic operating on a first platform receives a request to generate a backup asset, the request including a first data asset. In some embodiments, the first platform includes a hardware security module (HSM). In some embodiments, the first data asset may be generated by the second platform. The first data asset may, at least in part, be used to encrypt data.

At operation 404, processing logic, responsive to receiving the request, generates a second data asset. In some embodiments, the second data asset includes a symmetric cryptographic key.

At operation 406, processing logic operating on a first platform generates a third data asset based on the second data asset and an asset list. In some embodiments, generating the third data asset includes signing the asset list using a hash function and the second data asset. In some embodiments, the signing may be performed by a keyed-hashed messaged authentication code (HMAC).

At operation 408, processing logic generates a fourth data asset based on the asset list. In some embodiments, identifying secure data assets associated with the asset list and signing the cryptographic keys using a hash function and the second data asset. In some embodiments, the signing may be performed by an HMAC. In some embodiments, the secure data assets may be private cryptographic keys maintained with the first platform.

At operation 410, processing logic encrypts the second data asset using the first data asset. In some embodiments, the second data asset includes a symmetric cryptographic key. In some embodiments, the first data asset includes a public key of an asymmetric key pair

At operation 412, processing logic sends the encrypted second data asset, the third data asset, and the fourth data asset to a second platform.

FIG. 5 depicts a flow diagram of an example method of using a module running on a cryptographic device in executing a restore and verification procedure, in accordance with some embodiments of the disclosure.

At operation 502, processing logic receives a request to restore a backup asset. In some embodiments, the request includes a first data asset, a second data asset, a third data asset, an asset list, and a backup asset. In some embodiments, the data assets are received from a first platform by a second platform. In some embodiments, the first request is received by a processing logic component of an HSM executing at the second platform (e.g., of an HSM).

At operation 504, processing logic performs a restore operation of the backup asset (e.g., a backup image).

At operation 506, processing logic decrypts the first data asset using the second data asset.

At operation 508, processing logic performs a verification operation of the second data asset based on the decrypted first data asset and an asset list. In some embodiments, processing performs the verification operation of the second data asset by signing the asset list with a hashing function and the decrypted first data asset. In some embodiments, signing the asset list may be performed by an HMAC function. In some embodiments, performing the verification operation of the second data asset includes comparing the signed asset list with the second data asset and determining that the signed asset list and the second data asset match.

At operation 510, processing logic performs a verification operation on the third data asset based on the decrypted first data asset and the asset list. In some embodiments, the verification operation includes identifying a secure data asset from the asset list. In some embodiments, the secure data asset is at least one cryptographic key. In some embodiments, verifying the third data asset includes signing the secure data asset using a hash function and the first data asset. In some embodiments, the signing may be performed by an HMAC function. In some embodiments, the verification operation of the third data asset includes comparing the signed secure data asset with the third data asset and determining that the signed secure data asset and the third data asset match.

At operation 512, processing logic determines that the verification operation of the second data asset and the verification operation of the third data asset were successful. Responsive to determining that the verification operation of the second data asset and the verification operation of the third data asset were successful, processing logic sends, to the first platform, a response indicating that the restore operation of the backup asset was successfully performed.

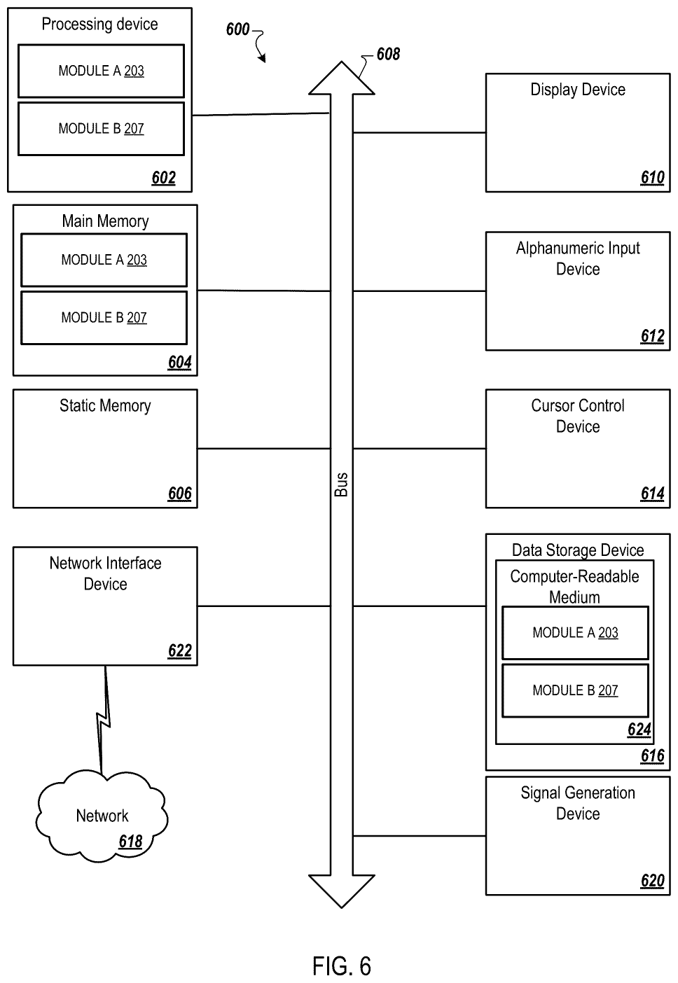

FIG. 6 is a block diagram illustrating an exemplary computer system 600, in accordance with some embodiments of the disclosure. The computer system 600 executes one or more sets of instructions that cause the machine to perform any one or more of the methodologies discussed herein. Set of instructions, instructions, and the like may refer to instructions that, when executed by computer system 600, cause computer system 600 to perform one or more operations of module A 203 and/or module B 207. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions of the CM system 100 and module A 203 and/or module B 207 for performing the operations discussed herein.

The computer system 600 may further include a network interface device 622 that provides communication with other machines over a network 618, such as a local area network (LAN), an intranet, an extranet, or the Internet. The computer system 600 also may include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a non-transitory computer-readable storage medium 624 on which is stored the sets of instructions of the CM system 100 of module A 203 and/or module B 207 embodying any one or more of the methodologies or functions described herein. The sets of instructions of the CM system 100 and of module A 203 and/or module B 207 may also reside, completely or at least partially, within the main memory 604 and/or within the processing device 602 during execution thereof by the computer system 600, the main memory 604 and the processing device 602 also constituting computer-readable storage media. The sets of instructions may further be transmitted or received over the network 618 via the network interface device 622.

While the example of the computer-readable storage medium 624 is shown as a single medium, the term “computer-readable storage medium” may include a single medium or multiple media (e.g., a centralized or distributed database, and/or associated caches and servers) that store the sets of instructions. The term “computer-readable storage medium” may include any medium that is capable of storing, encoding or carrying a set of instructions for execution by the machine and that cause the machine to perform any one or more of the methodologies of the disclosure. The term “computer-readable storage medium” may include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
receiving, by a first platform, a request to generate a verification package for restoring a backup image at a second platform;
responsive to receiving the request, generating a first data asset;
generating a second data asset based on the first data asset and an asset list associated with the backup image;
generating a third data asset based on the asset list; and
responding to the request by sending the verification package comprising the first data asset, the second data asset, and the third data asset.

2. The method of claim 1, wherein the first platform comprises a hardware security module (HSM).

3. The method of claim 1, wherein the first data asset comprises a symmetric key.

4. The method of claim 1, wherein generating the second data asset comprises:
signing the asset list using a hash function and the first data asset, wherein the signing of the asset list is performed via a hash-based message authentication code (HMAC) operation.

5. The method of claim 1, wherein the asset list is obtained from the second platform.

6. The method of claim 1, wherein generating the third data asset comprises:
identifying a secure data asset associated with the asset list; and
signing the secure data asset using a hash function and the first data asset, wherein signing of the secure data asset is performed via an HMAC operation.

7. The method of claim 6, wherein the secure data asset comprises at least one private cryptographic key.

8. The method of claim 1, further comprising encrypting the first data asset using a fourth data asset, wherein the fourth data asset is included in the request.

9. The method of claim 8, wherein the fourth data asset comprises a public key of an asymmetric key pair.

10. A method comprising:
receiving, by a processor, a request to restore a backup image, wherein the request comprises the backup image, a first data asset, a second data asset, a third data asset, and an asset list;
performing a restore operation on the backup image;
performing a verification operation of the second data asset based on the first data asset and the asset list;
performing a verification operation of the third data asset based on the asset list; and
responsive to determining that the verification operation of the second data asset and the verification operation of the third data asset were successful, sending a response indicating that the restore operation of the backup asset was successfully performed.

11. The method of claim 10, wherein performing the verification operation of the second data asset comprises:
signing the asset list using a hash function and the decrypted first data asset, wherein the signing is performed via an HMAC operation;
comparing the signed asset list with the second data asset; and
determining that the signed asset list and the second data asset match.

12. The method of claim 10, wherein performing the verification operation of the third data asset comprises:
identifying a secure data asset associated with the asset list, wherein the secure data asset comprises at least one cryptographic key;
signing the secure data asset using a hash function and the first data asset, wherein the signing of the secure data is performed via an HMAC operation;
comparing the signed secure data asset with the third data asset; and
determining that the signed secure data asset and the third data asset match.

13. The method of claim 10, further comprising decrypting the first data asset using a fourth data asset.

14. The method of claim 10, wherein the fourth data asset comprises a private key of an asymmetric key pair.

15. The method of claim 10, wherein the processor is comprised by an HSM.

16. A cryptographic management (CM) system, comprising:
a memory device; and
a processing device, coupled to the memory device, to perform operations:
receiving, by a first platform, a request to generate a verification package for restoring a backup image at a second platform;
responsive to receiving the request, generating a first data asset;
generating a second data asset based on the first data asset and an asset list associated with the backup image;
generating a third data asset based on the asset list; and
responding to the request by sending the verification package comprising the first data asset, the second data asset and the third data asset.

17. The system of claim 16, wherein generating the second data asset comprises:
signing the asset list using a hash function and the first data asset, wherein the signing of the asset list is performed via an HMAC operation.

18. The system of claim 16, wherein the asset list is obtained from the second platform.

19. The system of claim 16, wherein generating the third data asset comprises:
identifying a secure data asset associated with the asset list; and
signing the secure data asset using a hash function and the first data asset, wherein the signing of the secure data asset is performed via an HMAC operation.

20. The system of claim 19, wherein the operations further comprise:
encrypting the first data asset using a fourth data asset, wherein the fourth data asset is included in the request.
